(19) United States
(12) Patent Application Publication
(10) Pub. No.: US 2011/0269860 A1
(43) Pub. Date: Nov. 3, 2011

(54) FOAM EXPANSION AGENT COMPOSITIONS CONTAINING HYDROHALOOLEFIN BUTENE AND WATER AND THEIR USES IN THE PREPARATION OF POLYURETHANE AND POLYISOCYANURATE POLYMER FOAMS

(75) Inventors: JOSEPH ANTHONY CREAZZO, WILMINGTON, DE (US); GARY LOH, NEWARK, DE (US)

(73) Assignee: E.I. DU PONT DE NEMOURS AND COMPANY, Wilmington, DE (US)

(21) Appl. No.: 13/081,570

(22) Filed: Apr. 7, 2011

Related U.S. Application Data
(60) Provisional application No. 61/328,668, filed on Apr. 28, 2010.

(51) Int. Cl. C08G 18/32; C09K 3/00; C08J 9/04

(52) U.S. Cl. 521/131; 252/182.12

(57) ABSTRACT

A foam expansion agent composition is disclosed that includes water and a hydrohaloolefin of the formula CF₃CX═CHY, wherein X is selected from the group consisting of H, Cl and F, and Y is selected from the group consisting of H, Cl, F, CF₃ and CF₂CF₃. Also disclosed is a foam-forming composition that includes the foam expansion agent composition of this disclosure and an active hydrogen-containing compound having two or more active hydrogens. Also disclosed is a closed-cell polyurethane or polyisocyanurate polymer foam prepared from reaction of an effective amount of the foam-forming composition of this disclosure and a suitable polyisocyanate. Also disclosed is a process for producing a closed-cell polyurethane or polyisocyanurate polymer foam. The process involves reacting an effective amount of the foam-forming composition of this disclosure and a suitable polyisocyanate. Also disclosed is a process for using the closed-cell polyurethane or polyisocyanurate polymer foam of this disclosure. The process involves using such polymer foam at a temperature of no more than about the normal boiling point of the hydrohaloolefin which is used in the preparation of such polymer foam.

### FIELD OF THE INVENTION

The disclosure herein relates to foam expansion agents and their use in the preparation of polyurethane and polyisocyanurate foams. More particularly, the disclosure herein relates to foam expansion agent compositions comprising a hydrohaloolefin and water, the foam-forming compositions containing such foam expansion agent compositions, the preparation of polyurethane and polyisocyanurate foams using such foam-forming compositions and the use of so prepared polyurethane and polyisocyanurate foams.

### BACKGROUND OF THE INVENTION

Closed-cell polyurethane and polyisocyanurate polymer foams are widely used for insulation purposes, for example, in building construction and in the manufacture of energy efficient electrical appliances. In the construction industry, polyurethane/polyisocyanurate board stock is used in roofing and siding for its insulation and load-carrying capabilities. Poured and sprayed polyurethane foams are widely used for a variety of applications including insulating roofs, insulating large structures such as storage tanks, insulating appliances such as refrigerators and freezers, insulating refrigerated trucks and railcars, etc. The insulation performance of a closed-cell polyurethane or polyisocyanurate polymer foam is mainly determined by the thermal conductivity of the cell gas. In the industry, the insulation performance of a polymer foam is represented by the R-value.

All of these various types of polyurethane/polyisocyanurate foams require foam expansion agents (also known as blowing agents) for their manufacture. Insulating foams depend on the use of halocarbon foam expansion agents, not only to foam the polymer, but primarily for their low vapor thermal conductivity, a very important characteristic for insulation value. For example, hydrofluorocarbons (HFCs) have been employed as foam expansion agents for polyurethane foams. An example of an HFC employed in this application is HFC-245fa (1,1,1,3,3-pentafluoropropane). However, the HFCs are of concern due to their contribution to the “greenhouse effect”, i.e., they contribute to global warming. As a result of their contribution to global warming, the HFCs have come under scrutiny, and their widespread use may also be limited in the future.

Hydrocarbons have also been proposed as foam expansion agents. However, these compounds are flammable, and many are photochemically reactive, and as a result contribute to the production of ground level ozone (i.e., smog). Such compounds are typically referred to as volatile organic compounds (VOCs), and are subject to environmental regulations.

Boiling point of a foam expansion agent can affect the insulation performance of the resulting polymer foam. A high boiling point foam expansion agent may condense in the cell and lose its insulation effectiveness at low temperature. Normally, a foam expansion agent with higher boiling point condenses more severely at low temperatures and causes poorer insulation performance (i.e., lower R-value) of the polymer foam at low temperature applications.

Z-1,1,1,4,4,4-hexafluoro-2-butene has vapor thermal conductivity of 10.7 mW/mK at 25° C. and a normal boiling point of 33° C.

1,1,1,3,3-pentafluoropropane has vapor thermal conductivity of 12.7 mW/mK at 25° C. and a normal boiling point of 15° C.

Carbon dioxide has vapor thermal conductivity of 16.5 mW/mK at 25° C.

Japanese Patent No. 05179043 discloses and attempts to use Z-1,1,1,4,4,4-hexafluoro-2-butene as the foam expansion agent for polyurethane foams.

### SUMMARY OF THE INVENTION

This disclosure provides a foam expansion agent composition comprising (a) a hydrohaloolefin of the formula CF₃CX═CHY, wherein X is selected from the group consisting of H, Cl and F, and Y is selected from the group consisting of H, Cl, F, CF₃ and CF₂CF₃; and (b) water.

This disclosure also provides a foam-forming composition comprising the foam expansion agent composition of this disclosure and an active hydrogen-containing compound having two or more active hydrogens.

This disclosure also provides a closed-cell polyurethane or polyisocyanurate polymer foam prepared from reaction of an effective amount of the foam-forming composition of this disclosure and a suitable polyisocyanate.

This disclosure also provides a process for producing a closed-cell polyurethane or polyisocyanurate polymer foam. The process comprises reacting an effective amount of the foam-forming composition of this disclosure and a suitable polyisocyanate.

This disclosure also provides a process for using the closed-cell polyurethane or polyisocyanurate polymer foam of this disclosure. The process comprises using such polymer foam at a temperature of no more than about the normal boiling point of the hydrohaloolefin which is used in the preparation of such polymer foam.

### BRIEF SUMMARY OF THE DRAWINGS

FIG. 1 is a graphical representation of the effect of water content in the HFC-245fa foam expansion agent composition to the initial R-values of the resulting foams at different temperatures.

FIG. 2 is a graphical representation of the effect of water content in the Z-FO-1336m/z foam expansion agent composition to the initial R-values of the resulting foams at different temperatures.

FIG. 3 is a graphical representation of the comparison between HFC-245fa and Z-FO-1336m/z as regard to the effect of 12 mole % water content in the foam expansion agent compositions to the initial R-values of the resulting foams at different temperatures.

FIG. 4 is a graphical representation of the comparison between HFC-245fa and Z-FO-1336m/z as regard to the effect of 47 mole % water content in the foam expansion agent compositions to the initial R-values of the resulting foams at different temperatures.

FIG. 5 is a graphical representation of the comparison between HFC-245fa and Z-FO-1336m/z as regard to the effect of 71 mole % water content in the foam expansion agent compositions to the initial R-values of the resulting foams at different temperatures.

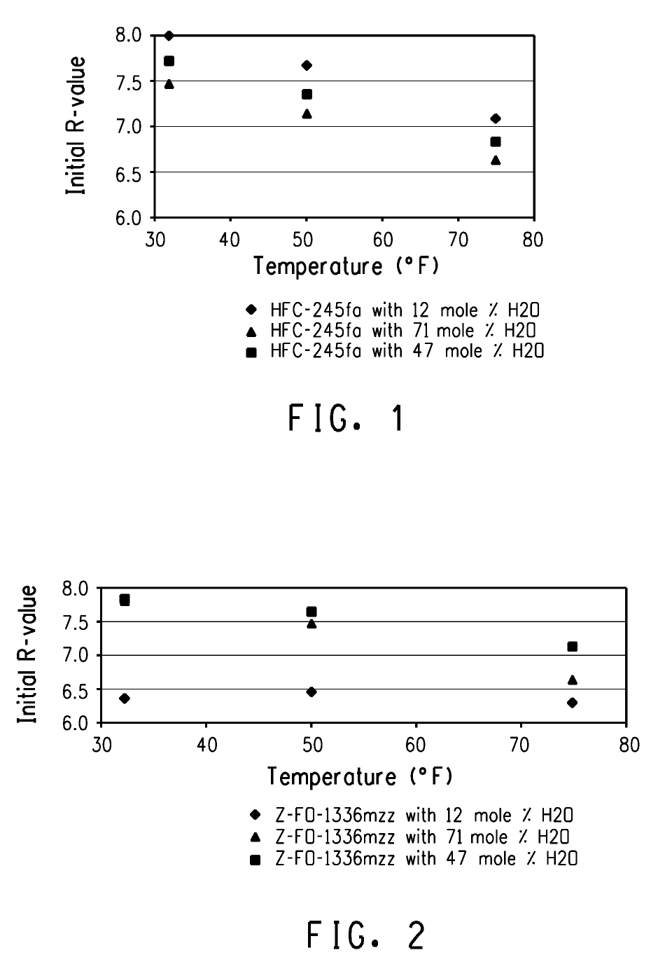

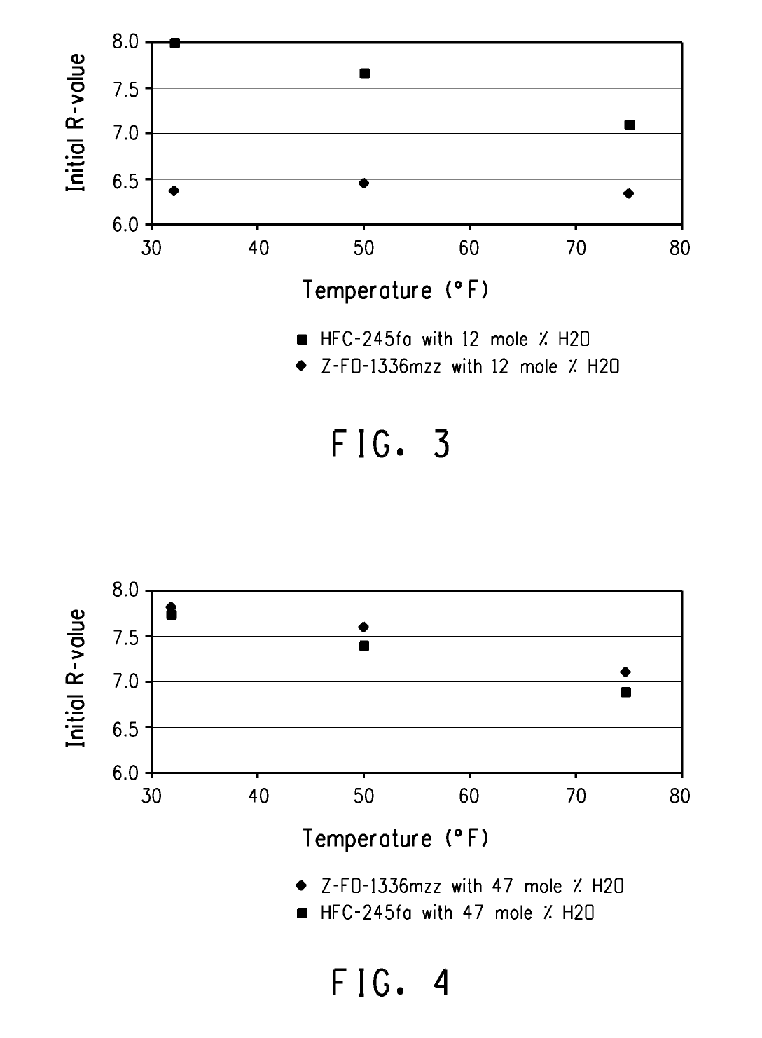

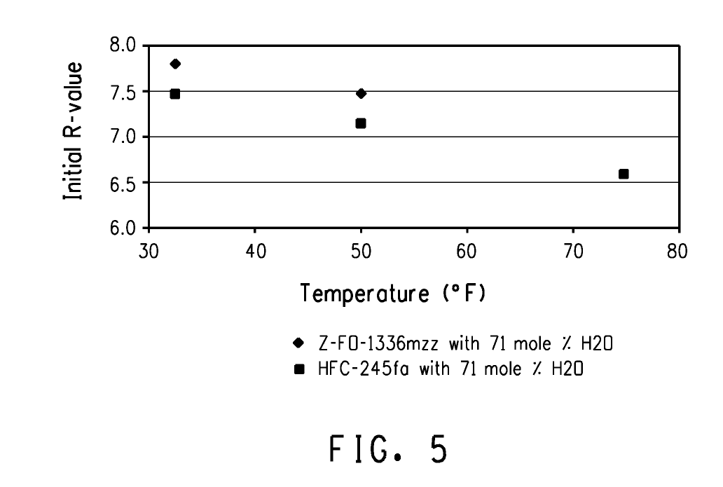

### DETAILED DESCRIPTION

The foregoing general description and the following detailed description are exemplary and explanatory only and are not restrictive of the invention, as defined in the appended claims. Other features and benefits of any one or more of the embodiments will be apparent from the following detailed description, and from the claims.

In some circumstances, water may be present in a foam expansion agent composition in the preparation of polyurethane and polyisocyanurate polymer foams. During the process, water reacts with polyisocyanate to form carbon dioxide (CO₂) which serves as an additional foam expansion agent. Since carbon dioxide has high vapor thermal conductivity, the presence of water in a foam expansion agent composition normally negatively affects the insulation performance of the resulting polymer foam. It was surprisingly found through experiments that the water presence in a foam expansion agent composition comprising Z-1,1,1,4,4,4-hexafluoro-2-butene (Z—CF₃CH═CHCF₃, Z-FC-1336m/z, Z-FO-1336m/z) improves insulation performance (i.e., R-value) of the resulting polymer foam.

As indicated above, this disclosure provides a foam expansion agent composition comprising (a) a hydrohaloolefin of the formula CF₃CX═CHY, wherein X is selected from the group consisting of H, Cl and F, and Y is selected from the group consisting of H, Cl, F, CF₃ and CF₂CF₃; and (b) water.

Some hydrohaloolefins of the formula CF₃CX═CHY, such as CF₃CH═CHF, CF₃CH═CHCF₃, CF₃CH═CHCF₂CF₃ and CF₃CH═CHCl, may exist as different configurational isomers or stereoisomers. When the specific isomer is not designated, the present disclosure is intended to include all single configurational isomers, single stereoisomers, or any combination thereof. For instance, CF₃CH═CHCF₃ is meant to represent the E-isomer, Z-isomer, or any combination or mixture of both isomers in any ratio.

The hydrohaloolefins of the formula CF₃CX═CHY as used herein are available commercially or may be prepared by processes known in the art. For example, CF₃CH═CHF is a known compound, and its preparation method has been disclosed, for example, in U.S. Patent Publication No. 2005-0020862-A1, hereby incorporated by reference in its entirety. For another example, CF₃CH═CHCF₃ is a known compound, and its preparation method has been disclosed, for example, in U.S. Patent Publication No. 2009-0012335-A1, hereby incorporated by reference in its entirety. For yet another example, CF₃CH═CHCF₂CF₃ is a known compound, and its preparation method has been disclosed, for example, in PCT Publication No. WO2008/057513, hereby incorporated by reference in its entirety. For yet another example, CF₃CH═CHCl is a known compound, and its preparation method has been disclosed, for example, in U.S. Pat. No. 5,777,184, hereby incorporated by reference in its entirety. For yet another example, CF₃CCl═CH₂ is a known compound which is available from SynQuest Laboratories, Inc. in Alachua, Fla. For yet another example, CF₃CF═CH₂ is a known compound, and its preparation method has been disclosed, for example, in PCT Publication No. WO2008/030440, hereby incorporated by reference in its entirety.

In some embodiments of this invention, the hydrohaloolefin used herein is selected from the group consisting of CF₃CH═CHF, CF₃CH═CHCF₃, CF₃CH═CHCF₂CF₃, CF₃CH═CHCl, CF₃CCl═CH₂ and CF₃CF═CH₂.

In some embodiments of this invention, the hydrohaloolefin used herein is Z—CF₃CH═CHCF₃, and the foam expansion agent composition comprises Z—CF₃CH═CHCF₃ and water. In some embodiments of this invention, the foam expansion agent composition comprises Z—CF₃CH═CHCF₃ and water, wherein the amount of water in said foam expansion agent composition is at least 12 mole %. In some embodiments of this invention, the foam expansion agent composition comprises Z—CF₃CH═CHCF₃ and water, wherein the amount of water in said foam expansion agent composition is at least 30 mole %. In some embodiments of this invention, the foam expansion agent composition comprises Z—CF₃CH═CHCF₃ and water, wherein the amount of water in said foam expansion agent composition is at least 47 mole %. In some embodiments of this invention, the foam expansion agent composition comprises Z—CF₃CH═CHCF₃ and water, wherein the amount of water in said foam expansion agent composition is at least 71 mole %.

Z—CF₃CH═CHCF₃ is a known compound, and its preparation method has been disclosed, for example, in U.S. Patent Publication No. 2008-0269532-A1, hereby incorporated by reference in its entirety.

The foam expansion agent composition of this disclosure can be prepared in any manner convenient to one skilled in this art, including simply weighing desired quantities of each component and, thereafter, combining them in an appropriate container at appropriate temperatures and pressures.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present invention, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

This disclosure also provides a foam-forming composition comprising (a) the foam expansion agent composition which comprises a hydrohaloolefin of the formula CF₃CX═CHY and water as described in this disclosure, and (b) an active hydrogen-containing compound having two or more active hydrogens.

In some embodiments of this invention, the foam-forming composition comprises (a) the foam expansion agent composition comprising Z—CF₃CH═CHCF₃ and water as described in this disclosure, and (b) an active hydrogen-containing compound having two or more active hydrogens. In some embodiments of this invention, these active hydrogens are in the form of hydroxyl groups.

The active hydrogen-containing compounds of this disclosure can comprise compounds having two or more groups that contain an active hydrogen atom reactive with an isocyanate group, such as described in U.S. Pat. No. 4,394,491; hereby incorporated by reference. Examples of such compounds have at least two hydroxyl groups per molecule, and more specifically comprise polyols, such as polyether or polyester polyols. Examples of such polyols are those which have an equivalent weight of about 50 to about 700, normally of about 70 to about 300, more typically of about 90 to about 270, and carry at least 2 hydroxyl groups, usually 3 to 8 such groups.

Examples of suitable polyols comprise polyester polyols such as aromatic polyester polyols, e.g., those made by transesterifying polyethylene terephthalate (PET) scrap with a glycol such as diethylene glycol, or made by reacting phthalic anhydride with a glycol. The resulting polyester polyols may be reacted further with ethylene—and/or propylene oxide—to form an extended polyester polyol containing additional internal alkyleneoxy groups.

Examples of suitable polyols also comprise polyether polyols such as polyethylene oxides, polypropylene oxides, mixed polyethylene-propylene oxides with terminal hydroxyl groups, among others. Other suitable polyols can be prepared by reacting ethylene and/or propylene oxide with an initiator having 2 to 16, generally 3 to 8 hydroxyl groups as present, for example, in glycerol, pentaerythritol and carbohydrates such as sorbitol, glucose, sucrose and the like polyhydroxy compounds. Suitable polyether polyols can also include alaphatic or aromatic amine-based polyols.

The foam-forming composition of this disclosure can be prepared in any manner convenient to one skilled in this art, including simply weighing desired quantities of each component and, thereafter, combining them in an appropriate container at appropriate temperatures and pressures.

This disclosure also provides processes for producing a closed-cell polyurethane or polyisocyanurate polymer foam which comprises reacting an effective amount of the foam-forming compositions of this disclosure with a suitable polyisocyanate. In some embodiments of this invention, the hydrohaloolefin in the foam-forming compositions used in the processes for producing a closed-cell polyurethane or polyisocyanurate polymer foam hereinabove is Z—CF₃CH═CHCF₃.

By “effective amount of the foam-forming composition” is meant an amount of the foam-forming composition, which, when reacted with a suitable polyisocyanate, results in a closed-cell polyurethane or polyisocyanurate polymer foam.

By “a suitable polyisocyanate” is meant a polyisocyanate which can react with foam-forming compositions of this disclosure to form closed-cell polyurethane or polyisocyanurate polymer foams.

Typically, before reacting with a suitable polyisocyanate, the active hydrogen-containing compound and optionally other additives are mixed with the foam expansion agent composition to form a foam-forming composition. Such foam-forming composition is typically known in the art as an isocyanate-reactive preblend, or B-side composition.

When preparing polyurethane or polyisocyanurate polymer foams, the polyisocyanate reactant is normally selected in such proportion relative to that of the active hydrogen-containing compound that the ratio of the equivalents of isocyanate groups to the equivalents of active hydrogen groups, i.e., the foam index, is from about 0.9 to about 10 and in most cases from about 1 to about 4.

While any suitable polyisocyanate can be employed in the instant process, examples of suitable polyisocyanates useful for making polyurethane or polyisocyanurate foam comprise at least one of aromatic, aliphatic and cycloaliphatic polyisocyanates, among others. Representative members of these compounds comprise diisocyanates such as meta- or paraphenylene diisocyanate, toluene-2,4-diisocyanate, toluene-2,6-diisocyanate, hexamethylene-1,6-diisocyanate, tetramethylene-1,4-diisocyanate, cyclohexane-1,4-diisocyanate, hexahydrotoluene diisocyanate (and isomers), napthylene-1,5-diisocyanate, 1-methylphenyl-2,4-phenyldiisocyanate, diphenylmethane-4,4-diisocyanate, diphenylmethane-2,4-diissocyanate, 4,4-biphenylenediisocyanate and 3,3-dimethyoxy-4,4 biphenylenediisocyanate and 3,3-dimethyldiphenylpropane-4,4-diisocyanate; triisocyanates such as toluene-2,4,6-triisocyanate and polyisocyanates such as 4,4-dimethyldiphenylmethane-2,2,5,5-tetraisocyanate and the diverse polymethylenepoly-phenylopolyisocyanates, mixtures thereof, among others.

A crude polyisocyanate may also be used in the practice of this invention, such as the crude toluene diisocyanate obtained by the phosgenating a mixture comprising toluene diamines, or the crude diphenylmethane diisocyanate obtained by the phosgenating crude diphenylmethanediamine. Specific examples of such compounds comprise methylene-bridged polyphenylpolyisocyanates, due to their ability to crosslink the polyurethane.

It is often desirable to employ minor amounts of additives in preparing polyurethane or polyisocyanurate polymer foams. Among these additives comprise one or more members selected from the group consisting of catalysts, surfactants, flame retardants, preservatives, colorants, antioxidants, reinforcing agents, filler, antistatic agents, among others well known in this art.

Depending upon the composition, a surfactant can be employed to stabilize the foaming reaction mixture while curing. Such surfactants normally comprise a liquid or solid organosilicone compound. The surfactants are employed in amounts sufficient to stabilize the foaming reaction mixture against collapse and to prevent the formation of large, uneven cells. In one embodiment of this invention, about 0.1% to about 5% by weight of surfactant based on the total weight of all foaming ingredients (i.e. foam expansion agent composition+active hydrogen-containing compounds+polyisocyanates+additives) are used. In another embodiment of this invention, about 1.5% to about 3% by weight of surfactant based on the total weight of all foaming ingredients are used.

One or more catalysts for the reaction of the active hydrogen-containing compounds, e.g. polyols, with the polyisocyanate may be also employed. While any suitable urethane catalyst may be employed, specific catalyst comprise tertiary amine compounds and organometallic compounds. Exemplary such catalysts are disclosed, for example, in U.S. Pat. No. 5,164,419, which disclosure is incorporated herein by reference. For example, a catalyst for the trimerization of polyisocyanates, such as an alkali metal alkoxide, alkali metal carboxylate, or quaternary amine compound, may also optionally be employed herein. Such catalysts are used in an amount which measurably increases the rate of reaction of the polyisocyanate. Typical amounts of catalysts are about 0.1% to about 5% by weight based on the total weight of all foaming ingredients.

In the process of the invention for making a polyurethane or polyisocyanurate polymer foam, the active hydrogen-containing compound (e.g. polyol), polyisocyanate, foam expansion agent composition and other components are contacted, thoroughly mixed, and permitted to expand and cure into a cellular polymer. The mixing apparatus is not critical, and various conventional types of mixing head and spray apparatus are used. By conventional apparatus is meant apparatus, equipment, and procedures conventionally employed in the preparation of polyurethane and polyisocyanurate polymer foams in which conventional foam expansion agents, such as fluorotrichloromethane (CCl₃F, CFC-11), are employed. Such conventional apparatus are discussed by: H. Boden et al. in chapter 4 of the Polyurethane Handbook, edited by G. Oertel, Hanser Publishers, New York, 1985; a paper by H. Grunbauer et al. titled “Fine Celled CFC-Free Rigid Foam—New Machinery with Low Boiling Blowing Agents” published in Polyurethanes 92 from the Proceedings of the SPI 34th Annual Technical/Marketing Conference, Oct. 21-Oct. 24, 1992, New Orleans, La.; and a paper by M. Taverna et al. titled “Soluble or Insoluble Alternative Blowing Agents? Processing Technologies for Both Alternatives, Presented by the Equipment Manufacturer”, published in Polyurethanes World Congress 1991 from the Proceedings of the SPI/ISOPA Sep. 24-26, 1991, Acropolis, Nice, France. These disclosures are hereby incorporated by reference.

In some embodiments of this invention, a preblend of certain raw materials is prepared prior to reacting the polyisocyanate and active hydrogen-containing components. For example, it is often useful to blend the polyol(s), foam expansion agent composition, surfactant(s), catalysts(s) and other foaming ingredients, except for polyisocyanates, and then contact this blend with the polyisocyanate. Alternatively, all the foaming ingredients may be introduced individually to the mixing zone where the polyisocyanate and polyol(s) are contacted. It is also possible to pre-react all or a portion of the polyol(s) with the polyisocyanate to form a prepolymer.

The compositions and processes of this invention are applicable to the production of all kinds of expanded polyurethane and polyisocyanurate polymer foams, including, for example, integral skin, RIM and flexible foams, and in particular rigid closed-cell polymer foams useful in spray insulation, as pour-in-place appliance foams, or as rigid insulating board stock and laminates.

This disclosure also provides a closed-cell polyurethane or polyisocyanurate polymer foam prepared from reaction of an effective amount of the foam-forming composition of this disclosure with a suitable polyisocyanate. In some embodiments of this invention, the hydrohaloolefin in the foam-forming compositions used for the preparation hereinabove of such closed-cell polyurethane or polyisocyanurate polymer foam is Z—CF₃CH═CHCF₃. In some embodiments of this invention, such closed-cell polyurethane or polyisocyanurate polymer foam prepared hereinabove has an initial R-value greater than 6.0 ft²-hr-° F./BTU-in at about 23.9° C.

The closed-cell polyurethane or polyisocyanurate polymer foams used in the refrigerators, freezers, refrigerated trailers, walk-in cold-storage, et al. are subject to low temperatures. In these applications, a foam expansion agent may condense in the cell and lose its insulation effectiveness. Normally, it is advantageous to use a low boiling point foam expansion agent to make foams for low temperature applications. It was surprisingly found through experiments that the water presence in a foam expansion agent composition comprising Z—CF₃CH═CHCF₃ may elevate the R-value of the resulting closed-cell polyurethane or polyisocyanurate polymer foam above the R-value of the foam made by 1,1,1,3,3-pentafluoropropane under the same conditions.

By “normal boiling point” is meant the boiling temperature of a liquid at which vapor pressure is equal to one atmosphere.

This disclosure also provides a process which comprises using the closed-cell polyurethane or polyisocyanurate polymer foam of this disclosure at a temperature of no more than about the normal boiling point of the hydrohaloolefin in the foam-forming compositions used for the preparation of such closed-cell polyurethane or polyisocyanurate polymer foam. In some embodiments of this invention, the hydrohaloolefin used hereinabove is Z—CF₃CH═CHCF₃, and the amount of water in the foam expansion agent composition used for the preparation of the closed-cell polyurethane or polyisocyanurate polymer foam hereinabove is at least 47 mole %.

In some embodiments of this invention, the closed-cell polyurethane or polyisocyanurate polymer foam made from the foam expansion agent composition comprising Z—CF₃CH═CHCF₃ and at least 47 mole % of water in such foam expansion agent composition is used at temperatures of no more than about 23.9° C. (75 Fahrenheit). In some embodiments of this invention, such closed-cell polyurethane or polyisocyanurate polymer foam is used at temperatures of no more than about 10° C. (50 Fahrenheit). In some embodiments of this invention, such closed-cell polyurethane or polyisocyanurate polymer foam is used at temperatures of no more than about 0° C. (32 Fahrenheit).

Many aspects and embodiments have been described above and are merely exemplary and not limiting. After reading this specification, skilled artisans appreciate that other aspects and embodiments are possible without departing from the scope of the invention.

### EXAMPLES

The concepts described herein will be further described in the following examples, which do not limit the scope of the invention described in the claims.

Polyol A used in the following Examples is a sucrose/glycerine initiated polyether polyol (Voranol 490) purchased from Dow Chemicals Inc. at Midland, Mich., 49641-1206. Polyol A has viscosity of about 500 centerpoise at 25° C. The content of hydroxyl groups in Polyol A is equivalent to about 490 mg KOH per gram of the Polyol A.

Polyol B used in the following Examples is a glycerine initiated polyether polyol (VORANOL 270) purchased from Dow Chemicals Inc. at Midland, Mich., 49641-1206. Polyol B has viscosity of about 238 centerpoise at 25° C. The content of hydroxyl groups in Polyol B is equivalent to about 238 mg KOH per gram of the Polyol B.

Silicon type surfactant used in the following Examples is a polysiloxane (Dabco DC-5357) purchased from Air Products Inc. at 7201 Hamilton Blvd, Allentown Pa. 18195.

Amine catalyst A (Polycat 8) used in the following Examples is N,N-dimethylcyclohexylamine purchased from Air Products Inc. at 7201 Hamilton Blvd, Allentown Pa. 18195.

Amine catalyst B (Polycat 5) used in the following Examples is Pentamethyldiethylenetriamine purchased from Air Products Inc. at 7201 Hamilton Blvd, Allentown Pa. 18195.

Co-catalyst (Curithane 52) used in the following Examples is 2-methyl(n-methyl amino b-sodium acetate nonyl phenol) purchased from Air Products Inc. at 7201 Hamilton Blvd, Allentown Pa. 18195.

Polymethylene polyphenyl isocyanate (PAPI 27) used in the following Examples is purchased from Dow Chemicals, Inc. at Midland, Mich., 49641-1206.

Initial R-value refers to the polymer foam's insulation value (thermal resistance). It was measured using a LaserComp Fox 304 Thermal Conductivity Meter at a mean temperature of 32° F., 50° F. and 75° F. within 24 hours after the foam is made. The unit of R-value is ft²-hr-° F./BTU-in.

### Example 1 (Comparative)

Polyols, surfactant, catalysts, water and HFC-245fa were pre-mixed by hand at room temperature under atmospheric pressure and then mixed with polymethylene polyphenyl isocyanate. The resulting mixture was poured into a 8″×8″×2.5″ paper box to form the polyurethane foam. The foam showed uniform cell structure. The formulation and properties of the foam are shown in Table 1 below. In this example, 0.5 pbw (parts by weight) of water was used in the formulation. Totally 0.234 moles of water and HFC-245fa were used in the formulation. The amount of water in the foam expansion agent composition (HFC-245fa and water) was 12 mole %.

TABLE 1

| Components | Quantity (pbw) |
|---|---|
| Polyol A | 80 |
| Polyol B | 20 |
| Silicon type surfactant | 2.0 |
| Amine catalyst A | 3.0 |
| Amine catalyst B | 0.38 |
| Co-catalyst | 1.0 |
| Water | 0.5 |
| HFC-245fa | 27.6 |
| Polymethylene polyphenyl isocyanate | 125 |
| Foam Index | 1.1 |
| Foam density (pounds-per-cubic-feet) | 2.0 |
| Initial R-value (ft²-hr-° F./BTU-in) at 32° F. | 8.0 |
| Initial R-value (ft²-hr-° F./BTU-in) at 50° F. | 7.7 |
| Initial R-value (ft²-hr-° F./BTU-in) at 75° F. | 7.1 |

### Example 2 (Comparative)

Polyols, surfactant, catalysts, water and HFC-245fa were pre-mixed by hand at room temperature under atmospheric pressure and then mixed with polymethylene polyphenyl isocyanate. The resulting mixture was poured into a 8″×8″×2.5″ paper box to form the polyurethane foam. The foam showed uniform cell structure. The formulation and properties of the foam are shown in Table 2 below. In this example, 2 pbw of water was used in the formulation. Totally 0.234 moles of water and HFC-245fa were used in the formulation. The amount of water in the foam expansion agent composition (HFC-245fa and water) was 47 mole %.

TABLE 2

| Components | Quantity (pbw) |
|---|---|
| Polyol A | 80 |
| Polyol B | 20 |
| Silicon type surfactant | 2.0 |
| Amine catalyst A | 3.0 |
| Amine catalyst B | 0.38 |
| Co-catalyst | 1.0 |
| Water | 2.0 |
| HFC-245fa | 16.5 |
| Polymethylene polyphenyl isocyanate | 150 |
| Foam Index | 1.1 |
| Foam density (pounds-per-cubic-feet) | 2.0 |
| Initial R-value (ft²-hr-° F./BTU-in) at 32° F. | 7.7 |
| Initial R-value (ft²-hr-° F./BTU-in) at 50° F. | 7.4 |
| Initial R-value (ft²-hr-° F./BTU-in) at 75° F. | 6.9 |

### Example 3 (Comparative)

Polyols, surfactant, catalysts, water and HFC-245fa were pre-mixed by hand at room temperature under atmospheric pressure and then mixed with polymethylene polyphenyl isocyanate. The resulting mixture was poured into a 8″×8″×2.5″ paper box to form the polyurethane foam. The foam showed uniform cell structure. The formulation and properties of the foam are shown in Table 3 below. In this example, 3 pbw of water was used in the formulation. Totally 0.234 moles of water and HFC-245fa were used in the formulation. The amount of water in the foam expansion agent composition (HFC-245fa and water) was 71 mole %.

TABLE 3

| Components | Quantity (pbw) |
|---|---|
| Polyol A | 80 |
| Polyol B | 20 |
| Silicon type surfactant | 2.0 |
| Amine catalyst A | 3.0 |
| Amine catalyst B | 0.38 |
| Co-catalyst | 1.0 |
| Water | 3.0 |
| HFC-245fa | 9.0 |
| Polymethylene polyphenyl isocyanate | 166 |
| Foam Index | 1.1 |
| Foam density (pounds-per-cubic-feet) | 2.0 |
| Initial R-value (ft²-hr-° F./BTU-in) at 32° F. | 7.5 |
| Initial R-value (ft²-hr-° F./BTU-in) at 50° F. | 7.2 |
| Initial R-value (ft²-hr-° F./BTU-in) at 75° F. | 6.7 |

### Example 4

Polyols, surfactant, catalysts, water and Z-FO-1336m/z were pre-mixed by hand at room temperature under atmospheric pressure and then mixed with polymethylene polyphenyl isocyanate. The resulting mixture was poured into a 8″×8″×2.5″ paper box to form the polyurethane foam. The foam showed uniform cell structure. The formulation and properties of the foam are shown in Table 4 below. In this example, 0.5 pbw of water was used in the formulation. Totally 0.234 moles of water and Z-FO-1336m/z were used in the formulation. The amount of water in the foam expansion agent composition (Z-FO-1336m/z and water) was 12 mole %.

TABLE 4

| Components | Quantity (pbw) |
|---|---|
| Polyol A | 80 |
| Polyol B | 20 |
| Silicon type surfactant | 2.0 |
| Amine catalyst A | 3.0 |
| Amine catalyst B | 0.38 |
| Co-catalyst | 1.0 |
| Water | 0.5 |
| Z-FO-1336mzz | 33.8 |
| Polymethylene polyphenyl isocyanate | 125 |
| Foam Index | 1.1 |
| Foam density (pounds-per-cubic-feet) | 2.0 |
| Initial R-value (ft²-hr-° F./BTU-in) at 32° F. | 6.4 |
| Initial R-value (ft²-hr-° F./BTU-in) at 50° F. | 6.5 |
| Initial R-value (ft²-hr-° F./BTU-in) at 75° F. | 6.3 |

### Example 5

Polyols, surfactant, catalysts, water and Z-FO-1336m/z were pre-mixed by hand at room temperature under atmospheric pressure and then mixed with polymethylene polyphenyl isocyanate. The resulting mixture was poured into a 8″×8″×2.5″ paper box to form the polyurethane foam. The foam showed uniform cell structure. The formulation and properties of the foam are shown in Table 5 below. In this example, 2 pbw of water was used in the formulation. Totally 0.234 moles of water and Z-FO-1336m/z were used in the formulation. The amount of water in the foam expansion agent composition (Z-FO-1336m/z and water) was 47 mole %.

TABLE 5

| Components | Quantity (pbw) |
|---|---|
| Polyol A | 80 |
| Polyol B | 20 |
| Silicon type surfactant | 2.0 |
| Amine catalyst A | 3.0 |
| Amine catalyst B | 0.38 |
| Co-catalyst | 1.0 |
| Water | 2.0 |
| Z-FO-1336mzz | 20.2 |
| Polymethylene polyphenyl isocyanate | 150 |
| Foam Index | 1.1 |
| Foam density (pounds-per-cubic-feet) | 2.1 |
| Initial R-value (ft²-hr-° F./BTU-in) at 32° F. | 7.8 |
| Initial R-value (ft²-hr-° F./BTU-in) at 50° F. | 7.6 |
| Initial R-value (ft²-hr-° F./BTU-in) at 75° F. | 7.1 |

### Example 6

Polyols, surfactant, catalysts, water and Z-FO-1336m/z were pre-mixed by hand at room temperature under atmospheric pressure and then mixed with polymethylene polyphenyl isocyanate. The resulting mixture was poured into a 8″×8″×2.5″ paper box to form the polyurethane foam. The foam showed uniform cell structure. The formulation and properties of the foam are shown in Table 6 below. In this example, 3 pbw of water was used in the formulation. Totally 0.234 moles of water and Z-FO-1336m/z were used in the formulation. The amount of water in the foam expansion agent composition (Z-FO-1336m/z and water) was 71 mole %.

TABLE 6

| Components | Quantity (pbw) |
|---|---|
| Polyol A | 80 |
| Polyol B | 20 |
| Silicon type surfactant | 2.0 |
| Amine catalyst A | 3.0 |
| Amine catalyst B | 0.38 |
| Co-catalyst | 1.0 |
| Water | 3.0 |
| Z-FO-1336mzz | 11.0 |
| Polymethylene polyphenyl isocyanate | 166 |
| Foam Index | 1.1 |
| Foam density (pounds-per-cubic-feet) | 1.9 |
| Initial R-value (ft²-hr-° F./BTU-in) at 32° F. | 7.8 |
| Initial R-value (ft²-hr-° F./BTU-in) at 50° F. | 7.5 |
| Initial R-value (ft²-hr-° F./BTU-in) at 75° F. | 6.7 |

What is claimed is:

1. A foam expansion agent composition comprising:
(a) a hydrohaloolefin of the formula CF₃CX═CHY, wherein X is selected from the group consisting of H, Cl and F, and Y is selected from the group consisting of H, Cl, F, CF₃ and CF₂CF₃; and
(b) water.

2. The foam expansion agent composition of claim 1 wherein said hydrohaloolefin is selected from the group consisting of CF₃CH═CHF, CF₃CH═CHCF₃, CF₃CH═CHCF₂CF₃, CF₃CH═CHCl, CF₃CCl═CH₂ and CF₃CF═CH₂.

3. The foam expansion agent composition of claim 2 wherein said hydrohaloolefin is Z—CF₃CH═CHCF₃.

4. The foam expansion agent composition of claim 3 wherein the amount of water in said foam expansion agent composition is at least 12 mole %.

5. The foam expansion agent composition of claim 3 wherein the amount of water in said foam expansion agent composition is at least 30 mole %.

6. The foam expansion agent composition of claim 3 wherein the amount of water in said foam expansion agent composition is at least 47 mole %.

7. A foam-forming composition comprising:
(a) the foam expansion agent composition of claim 1; and
(b) an active hydrogen-containing compound having two or more active hydrogens.

8. The foam-forming composition of claim 7 wherein said hydrohaloolefin is Z—CF₃CH═CHCF₃.

9. The foam-forming composition of claim 8 wherein said active hydrogen-containing compound is a polyol.

10. The foam-forming composition of claim 9 wherein said active hydrogen-containing compound is a polyether polyol.

11. A closed-cell polyurethane or polyisocyanurate polymer foam prepared from reaction of an effective amount of the foam-forming composition of claim 7 with a suitable polyisocyanate.

12. The closed-cell polyurethane or polyisocyanurate polymer foam of claim 11 wherein said hydrohaloolefin is Z—CF₃CH═CHCF₃.

13. The closed-cell polyurethane or polyisocyanurate polymer foam of claim 12 wherein said polymer foam has an initial R-value greater than 6.0 ft²-hr-° F./BTU-in at about 23.9° C.

14. A process comprising using the closed-cell polyurethane or polyisocyanurate polymer foam of claim 11 at a temperature of no more than about the normal boiling point of said hydrohaloolefin.

15. A process for producing a closed-cell polyurethane or polyisocyanurate polymer foam comprising: reacting an effective amount of the foam-forming composition of claim 7 with a suitable polyisocyanate.
